(19) United States
(12) Patent Application Publication
(10) Pub. No.: US 2016/0248276 A1
(43) Pub. Date: Aug. 25, 2016

(54) WIRELESS POWER TRANSMISSION APPARATUS, WIRELESS POWER TRANSMISSION SYSTEM INCLUDING THE SAME AND WIRELESS POWER TRANSMISSION METHOD THEREOF

(71) Applicant: Electronics and Telecommunications Research Institute, Daejeon (KR)

(72) Inventors: Seon-Eui HONG, Daejeon (KR); JONG HWA KWON, Daejeon (KR)

(21) Appl. No.: 15/050,682

(22) Filed: Feb. 23, 2016

(30) Foreign Application Priority Data
Feb. 23, 2015 (KR) 10-2015-0025286

(51) Int. Cl. H02J 50/10; H02J 50/80

(52) U.S. Cl. CPC H02J 50/10; H02J 50/80

(57) ABSTRACT

Provided is a wireless power transmission including a power supplying unit configured to output external power as a power signal having a set frequency, a power transmitting unit configured to output the power signal from the power supplying unit as a wireless power signal of an EMF type, and a controller configured to output a power control signal for controlling an output level of the wireless power signal, wherein the controller calculates a SAR and inner body temperature variation amount by using EMF and temperature measurement data transmitted from the implantable medical device in the power transmission process, and outputs the power control signal according to a result of comparing the calculated SAR and inner body temperature variation amount with a reference value.

### CROSS-REFERENCE TO RELATED APPLICATIONS

This U.S. non-provisional patent application claims priority under 35 U.S.C. §119 of Korean Patent Application No. 10-2015-0025286, filed on Feb. 23, 2015, the entire contents of which are hereby incorporated by reference.

### BACKGROUND

The present disclosure herein relates to a wireless power transmission apparatus for an implantable medical device, a wireless power transmission system including the same, and a wireless power transmission method thereof, and more particularly, to a wireless power transmission apparatus for measuring an exposure level of a human body to electromagnetic fields during power transmission and controlling a transmission power level, a wireless power transmission system including the same, and a wireless power transmission method thereof.

The market of implantable medical device is rapidly growing with population aging and welfare activation. Application of the implantable medical device is extending to various disease treatment fields in order to assist in vulnerable function of human, and a power module thereof becomes essential to active treatment through the device. In order to use this smoothly, an additional cost and suffering are necessary. In order to address this, products using a wireless power transmission technique are being actively developed.

During power transmission by using a human body as a medium, the electromagnetic field (EMF) is absorbed to human tissues and the absorbed power increases a temperature of the human tissues to a certain level or greater. When this increase in temperature continues for a certain time or longer, corresponding tissues may be damaged. Like this, absorption of the EMF to the human tissues influences safety of human body,

Accordingly, an apparatus and method are required which are capable of observing variation in human body due to exposure to the EMF that occurs when power is supplied to a device inserted into the human body, and of enabling safe use of the device.

### SUMMARY

The present disclosure provides a wireless power transmission apparatus capable of measuring an exposure level of a human body exposed to an EMF that occurs when power is wirelessly transmitted to an implantable medical device, and controlling a power transmission level using the measure result, a wireless power transmission system including the same, and a wireless power transmission method thereof.

An embodiment of the inventive concept provides a wireless power transmission apparatus that wirelessly transmits power to an implantable medical device. The wireless power transmission apparatus includes: a power supplying unit configured to output external power as a power signal having a set frequency; a power transmitting unit configured to output the power signal from the power supplying unit as a wireless power signal of an electromagnetic field (EMF) type; and a controller configured to output a power control signal for controlling an output level of the wireless power signal, wherein the controller calculates a specific absorption rate (SAR) and inner body temperature variation amount by using EMF and temperature measurement data transmitted from the implantable medical device in the power transmission process, and outputs the power control signal according to a result of comparing the calculated SAR and inner body temperature variation amount with a reference value.

In an embodiment, when the SAR or inner body temperature variation amount is greater than the reference value, the controller may control the power transmitting unit to reduce an output level of the wireless power signal.

In an embodiment, when the SAR or inner body temperature variation amount is equal to or smaller than the reference value, the controller may control the power transmitting unit to maintain an output level of the wireless power signal.

In an embodiment, the wireless power transmission apparatus may further include a display or an LED display configured to display the SAR and inner body temperature variation amount.

In an embodiment, the power transmission unit may include: a transmission coil configured to output the power signal of the power supplying unit as the wireless power signal of the EMF type; and a transmission antenna configured to receive the EMF and temperature measurement data transmitted from the implantable medical device.

In an embodiment, the power may be transmitted to the implantable medical device in a magnetic resonance type.

In an embodiments of the inventive concept, a wireless power transmission system includes a wireless power transmission device; and a wireless power receiving device, wherein the wireless power receiving device receives a wireless power signal transmitted from the wireless power transmission device, converts the received wireless power signal to a DC voltage to supply the DC voltage to a load, and measures an EMF intensity of the received wireless power signal to transmit the EMF intensity to the wireless power transmission device, and the wireless power transmission device calculates a SAR and inner body temperature variation amount by using the EMF intensity and inner body temperature measured by the wireless power receiving device, and controls an output level of the wireless power signal transmitted according to a result of comparing the calculated SAR and inner body temperature variation with reference values.

In an embodiment, the wireless power receiving device may include a receiving coil configured to receive the wireless power signal, and a receiving antenna configured to transmit the measured data of the EMF intensity of the wireless power signal and inner body temperature to the wireless power transmission device, and the wireless power transmission device may include a transmission coil configured to transmit the wireless power signal and a transmission antenna configured to receive the data.

In an embodiment, the wireless power transmission system may further include a matching circuit configured to match a resonance frequency of the receiving coil with a resonance frequency of the transmission coil in a wireless power transmitting process.

In an embodiment, when the SAR or inner body temperature variation amount is greater than the reference value, the wireless power transmission device may reduce an output level of the wireless power signal.

In an embodiment, when the SAR or inner body temperature variation amount is equal to or smaller than the reference value, the wireless power transmission device may maintain an output level of the wireless power signal.

In an embodiment, the wireless power transmission device may include a display or an LED display configured to display the SAR and inner body temperature variation amount.

In an embodiment, the wireless power receiving device may be located in an implantable medical device to supply power to a power supplying unit of the implantable medical device.

In an embodiments of the inventive concept, a method for wirelessly transmitting power by a wireless power transmission device includes: transmitting a wireless power signal of an EMF type to a wireless power receiving device; receiving measurement data for an EMF intensity of the wireless power signal and inner body temperature from the wireless power receiving device; and controlling an output level of the wireless power signal by using the measurement data, wherein the controlling of the output level is performed by calculating the SAR and inner body temperature variation amount by using the measurement data, and using the calculated SAR and inner body temperature variation amount.

In an embodiment, the controlling of the output level may include reducing an output level of the wireless power signal, when the SAR or inner body temperature variation amount is greater than a reference value.

In an embodiment, the controlling of the output level may include maintaining an output level of the wireless power signal, when the SAR or inner body temperature variation amount is equal to or smaller than a reference value.

In an embodiment, the method may further include displaying the calculated SAR and inner body temperature variation amount on a display.

### BRIEF DESCRIPTION OF THE FIGURES

The accompanying drawings are included to provide a further understanding of the inventive concept, and are incorporated in and constitute a part of this specification. The drawings illustrate exemplary embodiments of the inventive concept and, together with the description, serve to explain principles of the inventive concept. In the drawings:

FIG. 1 illustrates a state where an implantable medical device according to an embodiment of the inventive concept is implanted in a human body;

FIG. 2 is a block diagram exemplarily illustrating a wireless power transmission apparatus and an implantable medical device that wirelessly receives power from the wireless power transmission apparatus;

FIG. 3 is a detailed block diagram of a wireless power transmission apparatus according to an embodiment of the inventive concept;

FIG. 4 is a detailed block diagram of a wireless power receiver according to an embodiment of the inventive concept;

FIG. 5 exemplarily illustrates power transmission and data transmission by a wireless power transmission system according to an embodiment of the inventive concept;

FIG. 6 is an exemplary flowchart of a wireless power transmission method of a wireless power transmission system; and

FIG. 7 is an exemplary flowchart of a method of adjusting, by a wireless power transmission apparatus, an output level of a wireless power signal.

### DETAILED DESCRIPTION

Exemplary embodiments of the inventive concept will be described below in more detail with reference to the accompanying drawings. The inventive concept may, however, be embodied in different forms and should not be construed as limited to the embodiments set forth herein. Rather, these embodiments are provided so that this disclosure will be thorough and complete, and will fully convey the scope of the inventive concept to those skilled in the art.

Hereinafter, embodiments of the present invention will be described in detail with reference to the accompanying drawings so that the present invention can be easily realized by those skilled in the art.

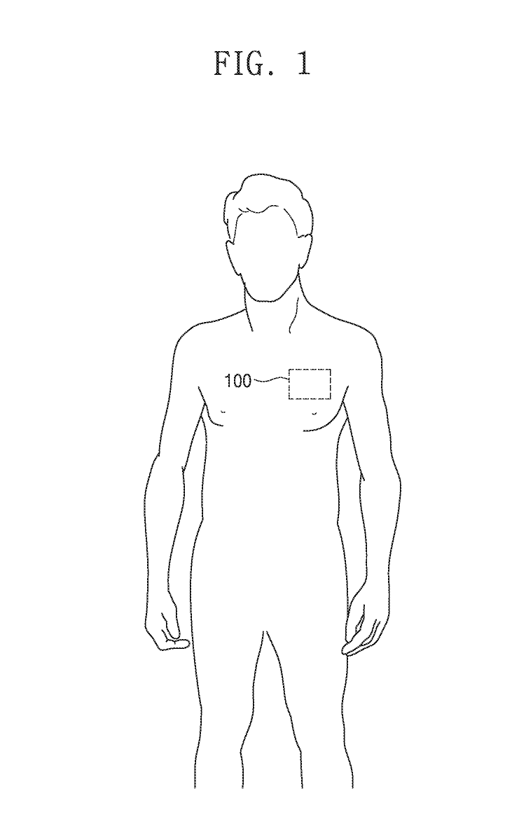

FIG. 1 illustrates a state where an implantable medical device 100 according to an embodiment of the inventive concept is implanted in a human body. The implantable medical device means a medical device implanted in a user's body to collect physiological/pathological state information on a user, or closely connected to organs of the user to perform treatment such as control operations for the organs.

Referring to FIG. 1, the implantable medical device 100 according to an embodiment of the inventive concept may be implanted in a body to perform set functions. For example, the implantable medical device 100 may be an implanted artificial pacemaker, implanted external defibrillator, implanted medical electric stimulator, implanted electrical urinary continence, or implanted medicine supplying pump. However, the implantable medical device 100 according to an embodiment of the inventive concept is not limited thereto and includes all medical devices that are implanted in a body to be used for medical purposes.

The implantable medical device 100 according to an embodiment of the inventive concept may include, as a power supply, a battery for performing a function set therein. The implantable medical device 100 according to an embodiment of the inventive concept may include a power receiving means for wirelessly charging the battery. The power receiving means may receive power transmitted in a wireless signal type to charge the battery through processes such as rectification, DC level conversion, and the like.

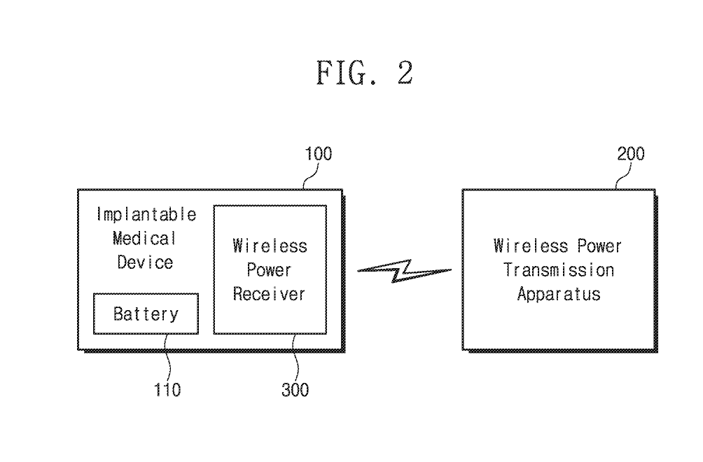

A description will be provided about a detailed configuration and operation of the implantable medical device 100 according to an embodiment of the inventive concept for wirelessly receiving power with reference to FIGS. 2 to 5.

FIG. 2 is a block diagram exemplarily illustrating a wireless power transmission apparatus 200 and the implantable medical device 100 that wirelessly receives power from the wireless power transmission apparatus 200. Referring to FIG. 2, the implantable medical device 100 according to an embodiment of the inventive concept may include a wireless power receiver 300 and a battery 110.

Hereinafter, a power transmission process will be described in detail between the wireless power transmission apparatus 200 and the implantable medical device 100 according to an embodiment of the inventive concept with reference to FIG. 2.

The battery 110 of the implantable medical device 100 supplies operation power of the implantable medical device 100. The battery 110 may be a rechargeable battery such as a Lithium-ion battery. The battery 110 may be discharged due to continuous use and accordingly require to be charged periodically or when necessary. The battery 110 according to an embodiment of the inventive concept may be wirelessly charged through the wireless power transmission apparatus 200.

The wireless power transmission apparatus 200 may wirelessly deliver power to the implantable medical device 100. In other words, the wireless power transmission apparatus 200 may transmit power in an EMF signal type to the wireless power receiver 300 of the implantable medical device 100. For example, the wireless power transmission apparatus 200 may transmit power in a magnetic induction type or magnetic resonance type to the wireless power receiver 300.

The wireless power receiver 300 may receive power in the EMF signal type from the wireless power transmission apparatus 200, convert the power to DC signal through a rectifying process, amplify and convert the DC signal to a voltage-signal, and then charge the battery 110.

The wireless power receiver 300 may measure an intensity and temperature of the EMF signal transmitted from the wireless power transmission apparatus 200. When the power in the EMF signal type is transmitted to the implantable medical device 100, a body part in which the implantable medical device 100 is implanted becomes exposed to the EMF. The wireless power receiver 300 may measure an exposure level of the body in the wireless power transmission process.

The wireless power transmission apparatus 200 may calculate a specific absorption rate (SAR) and a variation amount of inner body temperature by using the EMF exposure level and temperature measured by the wireless power receiver 300. In addition, the wireless power transmission apparatus 200 may adjust a transmission power level by using the calculated SAR and variation amount of inner body temperature. For example, when the calculated SAR and variation amount of inner body temperature respectively exceed set values, the transmission power level may be reduced. For example, when the calculated SAR and variation amount of inner body temperature are respectively equal to or smaller than set values, the transmission power level may be reduced.

As described above, the wireless power transmission apparatus 200 according to an embodiment of the invention may wirelessly deliver power to the implantable medical device 100. In addition, the transmission power level may be adjusted by using the exposure level of the body in the wireless power transmission process. Accordingly, the wireless power transmission apparatus 200 according to an embodiment of the inventive concept may reduce harmfulness to the body in the wireless power transmission process.

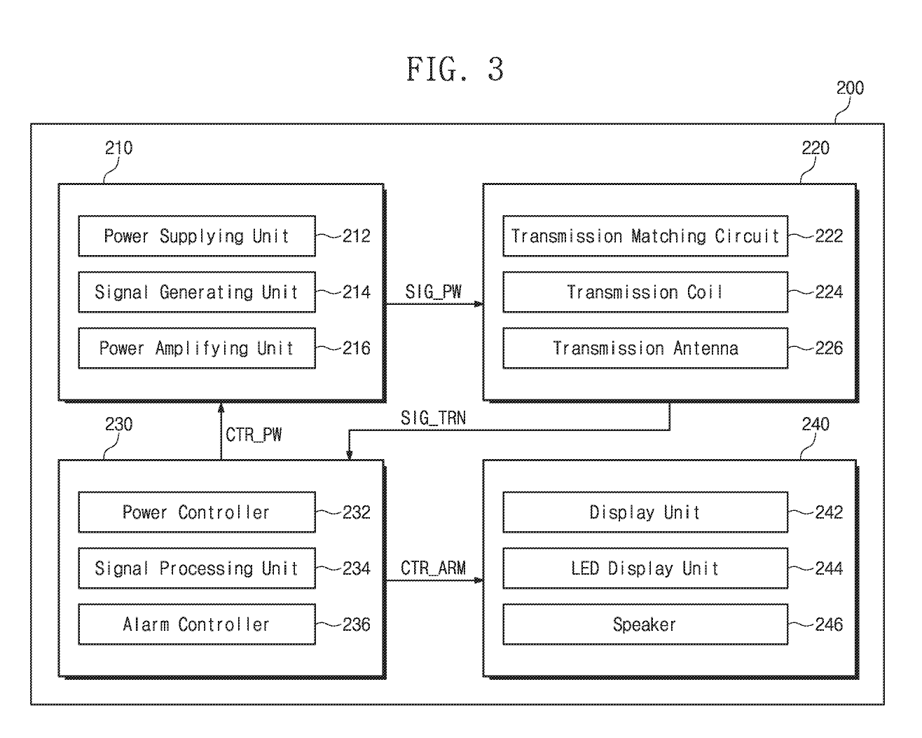

FIG. 3 is a detailed block diagram of the wireless power transmission apparatus 200 according to an embodiment of the inventive concept. Referring to FIG. 3, the wireless power transmission apparatus 200 may include a power supplying unit 210, a power transmitting unit 220, a controller 230, and a notifying unit 240. The power supplying unit 210 may include a power supplying unit 212, a signal generating unit 214, and a power amplifying unit 216. The power transmitting unit 220 may include a transmission matching circuit 222, a transmission coil 224, and a transmission antenna 226. The controller 230 may include a power controller 232, a signal processing unit 234, and a alarm controller 236. The notifying unit 240 may include a display unit 242, an LED display unit 244, and a speaker 246.

Hereinafter, an operation of the wireless power transmission apparatus 200 will be described in detail with reference to FIG. 3.

The power supplying unit 210 converts external power supplied through the power supplying unit 212 to an EMF signal, and outputs the EMF signal to the power transmitting unit 220.

The power supplying unit 212 receives power from the outside thereof. For example, such external power may be AC power of 220 v/60 Hz. The power supplying unit 212 may rectify the input external power to output a DC voltage.

The signal generating unit 214 may generate a signal having a frequency that the wireless power transmission apparatus 200 requires. A frequency band of the generated signal may be, for example, several MHz to several tens of MHz.

The power amplifying unit 216 converts the DC voltage having a certain level output from the power supplying unit to a signal type having a predetermined frequency by using a signal generated from the signal generating unit 214. In other words, a power signal SIG_PW for wirelessly transmitting the DC voltage may be generated. In addition, the power amplifying unit 216 may adjust an output level of the power signal SIG_PW. The power amplifying unit 216 may further include a protection circuit for preventing performance degradation and malfunction thereof.

The power transmitting unit 220 may transmit the power signal SIG_PW received from the power supplying unit 210 to the wireless power receiver 300 of the implantable medical device 100 through the transmission coil 224. In other words, the power transmitting unit 220 receives the power signal SIG_PW to radiate the wireless power signal in the EMF signal type to the wireless power receiver 300. In addition, the power transmitting unit 220 may receive EMF and temperature measurement data transmitted from the wireless power receiver 300 of the implantable medical device 100.

The transmission matching circuit 222 may change a resonance frequency of the transmission coil 224. To this end, the transmission matching circuit 222 may include a variable capacitor. The transmission matching circuit 222 may be located at a rear end of the transmission coil 224 and match impedance between the transmission coil 224 and the power supplying unit 210.

The transmission coil 224 may transmit the power signal SIG_PW received from the power supplying unit 210 to the wireless power receiver 300 of the implantable medical device 100. In other words, the transmission coil 224 may radiate the power signal SIG_PW as a wireless power signal of the EMF signal type. The wireless power supplying apparatus 200 and the transmission coil 224 of the wireless power receiver 300 according to an embodiment of the inventive concept may be configured with a loop antenna, not in a coil type.

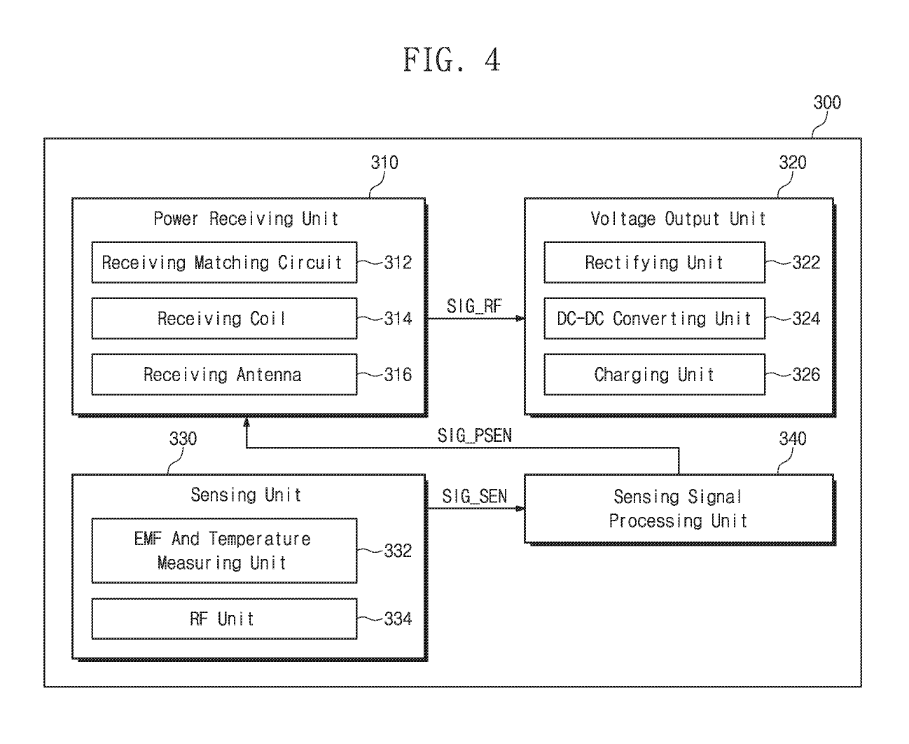

The transmission antenna 226 may receive the EMF and temperature measurement data transmitted from the wireless power receiver 300 of the implantable medical device 100. The EMF measurement data may be data measured by an EMF and temperature measuring unit 332 (see FIG. 4) of the wireless power receiver 300, and data for an inner body EMF exposure level in the wireless power transmission process.

In other words, the transmission coil 224 is used for transmitting power to the implantable medical device 100, and the transmission antenna 226 is used for communicating with the implantable medical device 100. The transmission antenna 226 may be used for transmitting power to the implantable medical device 100 instead of the transmission coil 224.

The controller 230 may calculate the SAR and inner body temperature variation amount by using the EMF and temperature measurement data received through the transmission antenna 226. The controller 230 may control the transmission power level according to the calculated SAR and inner body temperature variation amount. The controller 230 may control the notifying unit 240 to display the calculated SAR and inner body temperature variation amount as visual or auditory information.

The signal processing unit 234 may process a transmission signal SIG_TRN for the EMF exposure level received from the transmission antenna 226 to calculate the SAR and inner body temperature variation amount. For example, the SAR may be calculated according to the following Equations (1) and (2).

$$S A R = \frac{σ {E}^{2}}{ρ} \qquad ( 1 )$$

where σ denotes a conductivity (S/m) of a tissue, ρ denotes a density (kg/m³) of a tissue, and E denotes an intensity (V/m) of electric field.

$$S A R = ci \frac{Δ t}{Δ T} \qquad ( 2 )$$

where ci denotes a specific heat capacity J/kg ° C., Δt denotes an exposure time, and ΔT denotes a temperature variation rate.

The calculated SAR and inner body temperature variation amount may be transmitted to the power controller 232 and alarm controller 236.

The power controller 232 compares the calculated SAR and inner body temperature variation amount with reference values to output a power control signal CTR_PW capable of controlling the power transmission level according to the comparison result. For example, when the calculated SAR is greater than the reference value, the signal processing unit 234 may output the power control signal CTR_PW for controlling the transmission power level to be lowered. For example, when the calculated inner body temperature variation amount is greater than the reference value, the signal processing unit 234 may output the power control signal CTR_PW for controlling the transmission power level to be lowered. The power amplifying unit 216 may adjust an output level of the wireless power signal SIG_PW in response to the generated power control signal CTR_PW.

The alarm controller 236 may output a notification control signal CTR_ARM for controlling the notifying unit 240 so that information on the input SAR and inner body temperature variation amount are displayed on the notifying unit 240. The notification control signal CTR_ARM may control the notifying unit 240 so that the SAR and inner body temperature variation amount are displayed as visual information through the display unit 242. Alternatively, the notification control signal CTR_ARM may control the notifying unit 240 so that the SAR and inner body temperature variation amount are displayed through the LED display unit 244 and speaker 246. For example, when the SAR and inner body temperature variation amount exceed the reference values, the alarm controller 236 may generate the notification control signal CTR_ARM to warn a user visually or acoustically through the LED display unit 244 or the speaker 246.

The notifying unit 240 may visually display information on the SAR and inner body temperature variation amount. When the SAR and inner body temperature variation amount exceed the reference values, the alarm controller 236 may warn the user through the LED display unit 244 or the speaker 246.

The display unit 242 may be a liquid crystal display device, touch screen, or the like capable of visually displaying the SAR and inner body temperature variation amount.

The LED display unit 244 may be configured with one or a plurality of LED elements to display the SAR and inner body temperature variation amount or the foregoing warning display by an operation of turning on/ turning off the LED elements.

The speaker 246 may warn the user in a sound type.

As described above, the wireless power transmission apparatus 200 according to an embodiment of the invention may wirelessly transmit power to the implantable medical device 100. In addition, the wireless power transmission apparatus 200 may calculate the SAR and inner body temperature variation amount by using the EMF measured in the power transmission process and adjust the transmission power level by using the calculated result. Accordingly, the wireless power transmission apparatus 200 according to an embodiment of the inventive concept may secure body safety for exposure to the EMF by measuring the EMF exposure level in real time and adjusting the transmission power level using the EMF this.

FIG. 4 is a detailed block diagram of a wireless power receiver 300 according to an embodiment of the inventive concept.

Referring to FIG. 4, the wireless power transmission apparatus 200 may include a power receiving unit 310, a voltage output unit 320, a sensing unit 230, and a sensing signal processing unit 340. The power receiving unit 310 may include a receiving matching circuit 312, a receiving coil 314, and a receiving antenna 316. The voltage output unit 320 may include a rectifying unit 322, a DC-DC converting unit 324, and a charging unit 326. The sensing unit 330 may include an EMF and temperature measuring unit 332, and an RF unit 334.

Hereinafter, an operation of the wireless power transmission device 300 will be described in detail with reference to FIG. 4.

The power receiving unit 310 may receive power transmitted from the wireless power transmission apparatus 200. The power receiving unit 310 may transmit sensed EMF data to the wireless power transmission apparatus 200.

The receiving matching circuit 312 may change a resonance frequency of the receiving coil 314. To this end, the receiving matching circuit 312 may include a variable capacitor. For example, the receiving matching circuit 312 may change a resonance frequency of the receiving coil 314 to be matched with the resonance frequency of the transmission coil 224. When the resonance frequency of the receiving coil 314 matches with the resonance frequency of the transmission coil 224, maximum power may be delivered.

The receiving coil 314 may receive power transmitted in the EMF signal type by the transmission coil 224. When the wireless power supplying apparatus 200 and the transmission coil 224 of the wireless power receiver 300 according to an embodiment of the inventive concept deliver power in a magnetic induction type, the receiving coil 224 may be configured with a loop antenna, not in a coil type. The receiving coil 214 may output the received power signal SIG_RF of the EMF signal type to the rectifying unit 322. The receiving antenna 316 may transmit the EMF and temperature data sensed by the sensing unit 330 to the wireless power transmission apparatus 200.

The voltage output unit 320 may convert the power received by the receiving coil 312 to a DC voltage to charge the battery 110 (see FIG. 2).

The rectifying unit 322 may rectify the power of the EMF type received by the receiving coil 312 to convert to the DC voltage.

The DC-DC converting unit 324 may convert the DC voltage converted by the rectifying unit 322 to a DC voltage having a level suitable for charging the battery 110.

The charging unit 326 may charge the battery 110 by using the DC voltage converted by the DC-DC converting unit 324. The charging unit 326 may further include an overcharge prevention circuit for preventing overcharging the battery 110.

The sensing unit 330 may measure a magnitude of the EMF and a temperature absorbed to the body in the wireless power transmission process.

The EMF and temperature measuring unit 332 may receive the exposure level of EMF occurring during power transmission from the wireless power transmission apparatus 200 to the wireless power receiver 300. The EMF and temperature measuring unit 332 may be configured with an antenna or in a coil type capable of measuring the exposure level of EMF or a temperature sensor capable of measuring the temperature.

The RF unit 334 may remove noise from the EMF signal received by the EMF and temperature measuring unit 332 to amplify or attenuate a signal level. Alternatively, the RF unit 334 may convert the measure temperature to an analog signal.

The sensing signal processing device 340 may perform a function for processing a signal so that a sensing signal SIG_GEN transmitted from the sensing unit 330 is transmitted through the receiving state antenna 316. The processed sensing signal SIG_PSEN may be transmitted to the wireless power transmission apparatus 200 through the receiving antenna 316.

The wireless power receiver 300 according to an embodiment of the inventive concept may be located inside the implantable medical device 100. The wireless power receiver 300 according to an embodiment of the inventive concept may receive power from the wireless power transmission apparatus 200 to charge the battery 110 of the implantable medical device 100. In addition, the wireless power receiver 300 according to an embodiment of the inventive concept may measure the exposure level of the body to the EMF to transmit the exposure level to the wireless power transmission apparatus 200.

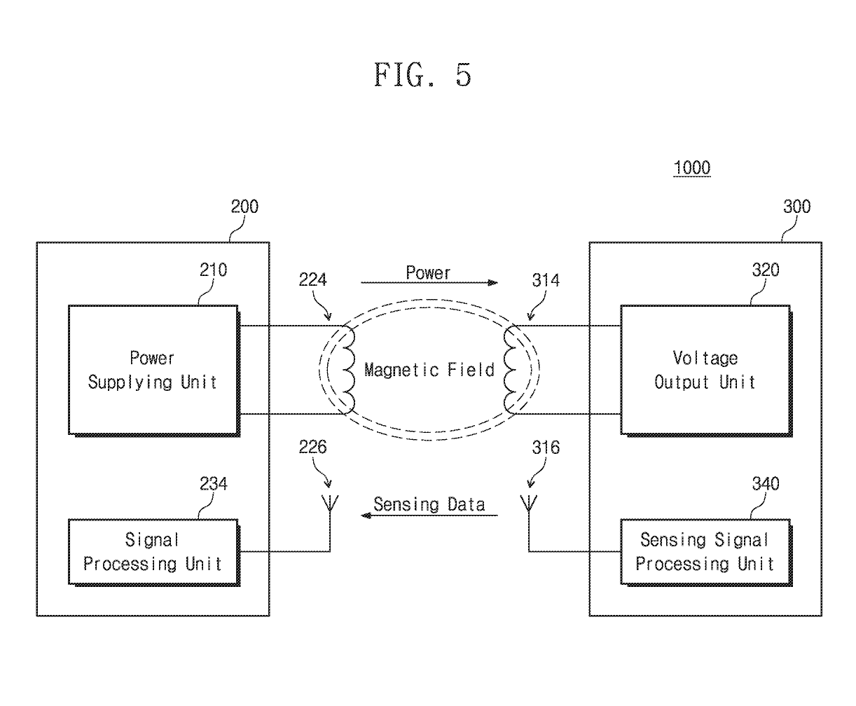

FIG. 5 exemplarily illustrates power transmission and data transmission by a wireless power transmission system 1000 according to an embodiment of the inventive concept. The wireless power transmission system 1000 according to an embodiment of the inventive concept may include the wireless power transmission apparatus 200 and the wireless power receiver 300.

Referring to FIG. 5, the wireless power transmission system 1000 according to an embodiment of the inventive concept may transmit power in a magnetic resonance type between the transmission coil 224 and the receiving coil 312.

In addition, the wireless power system 1000 according to an embodiment of the inventive concept may transmit EMF data sensed by the wireless power receiver 300 to the wireless power transmission apparatus 200 through the receiving state antenna 316. The wireless power transmission apparatus 200 may receive the sensed EMF data through the transmission antenna 316 and then calculate the SAR and inner body temperature variation amount using this. The wireless power transmission apparatus 200 may adjust a transmission power level by using the calculated SAR and variation amount of inner body temperature.

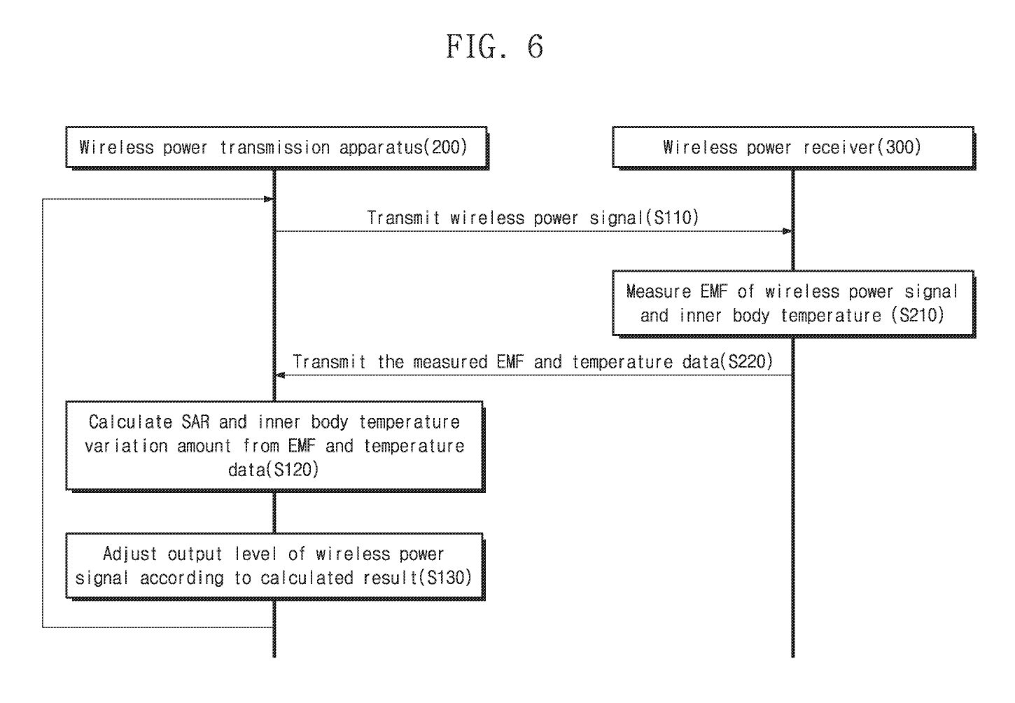

FIG. 6 is an exemplary flowchart of a wireless power transmission method of a wireless power transmission system 1000. Referring to FIG. 6, in the wireless power system 1000 according to an embodiment of the inventive concept, power is transmitted from the wireless power transmission apparatus 200 to the wireless power receiver 300. The wireless power receiver 300 may be located inside the implantable medical device 100.

Hereinafter, an operation of the wireless power transmission device 1000 will be described in detail with reference to FIG. 6.

The wireless power transmission apparatus 200 transmits a wireless power signal to the wireless power receiver 300 (operation S110). The wireless power transmission apparatus 200, as described above, receives external power to transmit a wireless power signal of the EMF signal type to the wireless power receiver 300 through the transmission coil 224.

The wireless power receiver 300 may receive the wireless power signal transmitted from the wireless power transmission apparatus 200 and convert the wireless power signal to a DC voltage to charge the battery 100. In addition, the wireless power receiver 300 may measure an EMF of the wireless power signal transmitted from the wireless power transmission apparatus 200 (operation S210). The measured EMF may be an intensity of an electric field of the wireless power signal.

The power receiver 300 may transmit the measured EMF data to the wireless power transmission apparatus 200 (operation S220). The measured EMF data may be transmitted through the receiving antenna 316 of the wireless power receiver 300.

The wireless power transmission apparatus 200 may receive the EMF and temperature data transmitted from the wireless power receiver 300 and calculate the SAR and inner body temperature variation amount by using the received EMF and temperature data (operation S120). The SAR may be calculated by using Equation (1) or (2) as described above.

The wireless power transmission apparatus 200 compares the calculated SAR and inner body temperature variation amount with the reference values and adjusts an output level of the wireless power signal (operation S130). For example, when the calculated SAR is greater than the reference value, the wireless power transmission apparatus 200 may reduce the output level of the transmitted wireless power signal. For example, when the calculated inner body temperature variation amount is greater than the reference value, the wireless power transmission apparatus 200 may reduce the output level of the transmitted wireless power signal. For example, when the calculated SAR is smaller than the reference value, the wireless power transmission apparatus 200 may maintain the output level of the transmitted wireless power signal.

The wireless power transmission device 200 may output the wireless power signal whose output level is adjusted to the wireless power receiver 300.

As described above, according to the wireless power transmission device 1000 according to an embodiment of the invention, the power may be delivered to the wireless power receiver 300 embedded in the body. In addition, the wireless power transmission system 1000 according to an embodiment of the inventive concept may measure the intensity of EMF influencing on the human body to adjust the transmission power level. In other words, the wireless power transmission system 1000 according to an embodiment of the inventive concept may prevent damage on the human body due to the EMF occurring in the wireless power transmission process.

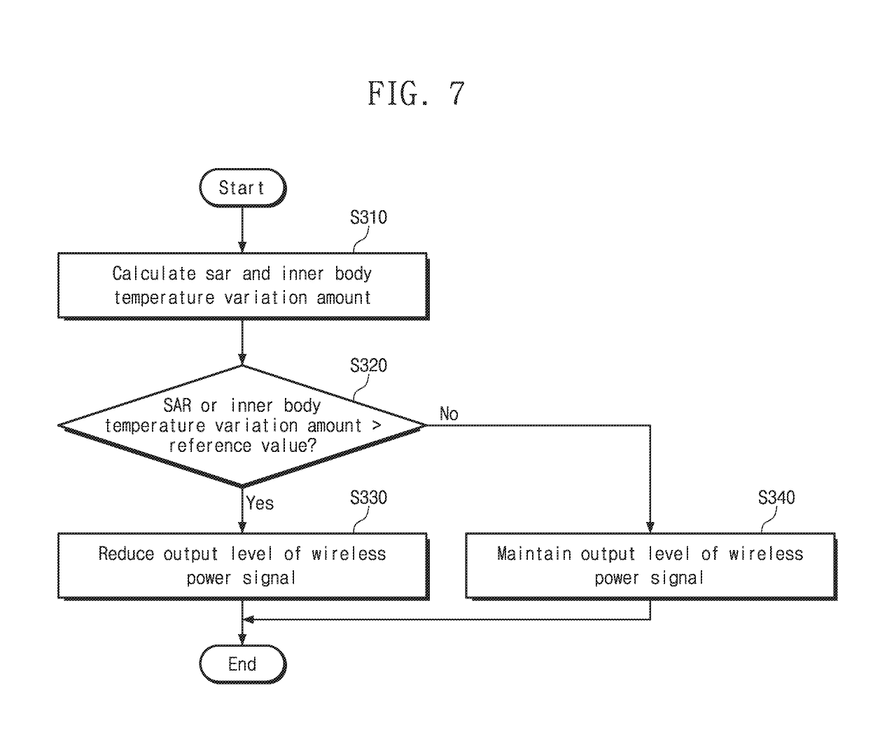

FIG. 7 is an exemplary flowchart of a method of adjusting, by a wireless power transmission device, an output level of a wireless power signal. Hereinafter, a method for adjusting, by the wireless power transmission apparatus 200, the output level of the wireless power signal will be described in detail with reference to FIG. 7.

Firstly, the wireless power transmission apparatus 200 may receive the EMF and temperature data measured for the body exposed to the EMF in the power transmission process.

Then, the wireless power transmission apparatus 200 calculates the SAR by using the received EMF and temperature data through Equation (1) or (2) (operation S310).

The wireless power transmission apparatus 200 compares the calculated SAR and inner body temperature variation amount with the prereference values (operation S320).

As the comparison result, when the calculated SAR or inner body temperature variation is greater than the reference value, the wireless power transmission apparatus 200 may reduce the output level of the transmitted wireless power signal.

As the comparison result, when the calculated SAR or inner body temperature variation amount is smaller than the reference value, the wireless power transmission apparatus 200 may maintain the output level of the transmitted wireless power signal (operation S340).

As described above, the wireless power transmission apparatus 200 according to an embodiment of the inventive concept adjusts the output level of the wireless power signal by using the SAR and inner body temperature variation amount calculated by using the EMF data measured by the wireless power receiver 300. Consequently, the wireless power transmission apparatus 200 according to an embodiment of the inventive concept may secure safety of a human body exposed to the EMF in the wireless power transmission process.

According to an embodiment of the inventive concept, power may be more easily supplied by wirelessly supplying power to an implantable medical device.

According to an embodiment of the inventive concept, safety may be secured by measuring an exposure level of a human body to an EMF during power transmission and controlling an output level of transmission power using the exposure level.

Thee above-disclosed subject matter is to be considered illustrative and not restrictive, and the appended claims are intended to cover all such modifications, enhancements, and other embodiments, which fall within the true spirit and scope of the inventive concept. Thus, to the maximum extent allowed by law, the scope of the inventive concept is to be determined by the broadest permissible interpretation of the following claims and their equivalents, and shall not be restricted or limited by the foregoing detailed description.

What is claimed is:

1. A wireless power transmission apparatus that wirelessly transmits power to an implantable medical device, the wireless power transmission apparatus comprising:
a power supplying unit configured to output a power signal having a set frequency as an external power;
a power transmitting unit configured to input the power signal from the power supplying unit and to output a wireless power signal of an electromagnetic field (EMF) type; and
a controller configured to output a power control signal for controlling an output level of the wireless power signal,
wherein the controller calculates a specific absorption rate (SAR) and inner body temperature variation amount by using EMF and temperature measurement data transmitted from the implantable medical device in the power transmission process, and outputs the power control signal according to a result of comparing the calculated SAR and inner body temperature variation amount with a reference value.

2. The wireless power transmission apparatus of claim 1, wherein when the SAR or inner body temperature variation amount is greater than the reference value, the controller controls the power transmitting unit to reduce an output level of the wireless power signal.

3. The wireless power transmission apparatus of claim 1, wherein when the SAR or inner body temperature variation amount is equal to or smaller than the reference value, the controller controls the power transmitting unit to maintain an output level of the wireless power signal.

4. The wireless power transmission apparatus of claim 1, further comprising a display or a light emitting diode (LED) display configured to display the SAR and inner body temperature variation amount.

5. The wireless power transmission apparatus of claim 1, wherein the power transmission unit comprises:
a transmission coil configured to output the power signal of the power supplying unit as the wireless power signal of the EMF type; and
a transmission antenna configured to receive the EMF and temperature measurement data transmitted from the implantable medical device.

6. The wireless power transmission apparatus of claim 1, wherein the power is transmitted to the implantable medical device in a magnetic resonance type.

7. A wireless power transmission system, comprising:
a wireless power transmission device; and
the wireless power receiving device configured to receive a wireless power signal transmitted from the wireless power transmission device, convert the received wireless power signal to a DC voltage to supply the DC voltage to a load, and measure an electromagnetic field (EMF) intensity of the received wireless power signal to transmit the EMF intensity to the wireless power transmission device,
wherein the wireless power transmission device calculates a SAR and inner body temperature variation amount by using the EMF intensity and inner body temperature measured by the wireless power receiving device, and controls an output level of the wireless power signal transmitted according to a result of comparing the calculated SAR and inner body temperature variation with reference values.

8. The wireless power transmission system of claim 7, wherein the wireless power receiving device comprises a receiving coil configured to receive the wireless power signal, and a receiving antenna configured to transmit the measured data of the EMF intensity of the wireless power signal and inner body temperature to the wireless power transmission device, and
the wireless power transmission device comprises a transmission coil configured to transmit the wireless power signal and a transmission antenna configured to receive the data.

9. The wireless power transmission system of claim 8, further comprising a matching circuit configured to match a resonance frequency of the receiving coil with a resonance frequency of the transmission coil in a wireless power transmitting process.

10. The wireless power transmission system of claim 7, wherein when the SAR or inner body temperature variation amount is greater than the reference value, the wireless power transmission device reduces an output level of the wireless power signal.

11. The wireless power transmission system of claim 7, wherein when the SAR or inner body temperature variation amount is equal to or smaller than the reference value, the wireless power transmission device maintains an output level of the wireless power signal.

12. The wireless power transmission device of claim 7, the wireless power transmission device comprises a display or an LED display configured to display the SAR and inner body temperature variation amount.

13. The wireless power transmission device of claim 7, wherein the wireless power receiving device is located in an implantable medical device to supply power to a power supplying unit of the implantable medical device.

14. A method for wirelessly transmitting power by a wireless power transmission device, the method comprises:
transmitting a wireless power signal of an electromagnetic field (EMF) type to a wireless power receiving device;
receiving measurement data for an EMF intensity of the wireless power signal and inner body temperature from the wireless power receiving device; and
controlling an output level of the wireless power signal by using the measurement data,
wherein the controlling of the output level is performed by calculating the SAR and inner body temperature variation amount by using the measurement data, and using the calculated SAR and inner body temperature variation amount.

15. The method of claim 14, wherein the controlling of the output level comprises reducing an output level of the wireless power signal, when the SAR or inner body temperature variation amount is greater than a reference value.

16. The method of claim 14, wherein the controlling of the output level comprises maintaining an output level of the wireless power signal, when the SAR or inner body temperature variation amount is equal to or smaller than a reference value.

17. The method of claim 14, further comprising:
displaying the calculated SAR and inner body temperature variation amount on a display.
